(19) United States
(12) Patent Application Publication
(10) Pub. No.: US 2025/0192486 A1
(43) Pub. Date: Jun. 12, 2025

(54) PREASSEMBLED WIRE AND METHOD FOR PREASSEMBLING A WIRE

(71) Applicant: Lisa Dräxlmaier GmbH, Vilsbiburg (DE)

(72) Inventors: Stephan HECKELSMÜLLER, Freising (DE); Michael FRIEDLMEIER, Hersbruck (DE)

(73) Assignee: Lisa Dräxlmaier GmbH, Vilsbiburg (DE)

(21) Appl. No.: 18/978,768

(22) Filed: Dec. 12, 2024

(30) Foreign Application Priority Data
Dec. 12, 2023 (DE) 10 2023 134 836.1

(51) Int. Cl. H01R 24/20; H01R 13/02; H01R 13/405; H01R 24/38

(52) U.S. Cl. CPC H01R 24/20; H01R 13/025; H01R 13/405; H01R 24/38

(57) ABSTRACT

A preassembled wire includes a wire having at least two coaxially arranged conductors with a stripped wire end, a main body including the stripped wire end, a first electrically conductive plate-shaped element and a second electrically conductive plate-shaped element. A first electrically conductive contact socket and a second electrically conductive contact socket are arranged in the main body. The first plate-shaped element extends between the first contact socket and the stripped wire end. One side of the first plate-shaped element is connected to the first contact socket and an opposing side of the first plate-shaped element is materially bonded to the stripped wire end. The second plate-shaped element extends between the second contact socket and the stripped wire end. One side of the second plate-shaped element is connected to the second contact socket and an opposing side of the second plate-shaped element is materially bonded to the stripped wire end.

### CROSS-REFERENCE TO RELATED APPLICATIONS

This application claims priority to and the benefit of DE 10 2023 134 836.1 filed on Dec. 12, 2023. The disclosure of the above application is incorporated herein by reference.

### FIELD

The present disclosure relates to a preassembled wire, which is configured for use in vehicles, in particular in motor vehicles, and a method for preassembling a wire, which is provided for use in vehicles.

### BACKGROUND

The statements in this section merely provide background information related to the present disclosure and may not constitute prior art.

Preassembly of wires has been known, for example, from AT 017 394 U1, DE 10 2021 107 921 B4, DE 297 12 306 U1, US 2021/0119376 A1, DE 10 2019 119 468 A1, WO 2023/024971 A1, US 2022/0224059 A1, or DE 10 2022 103 647 A1, wherein respectively stranded wires with corresponding connection options are provided. In this case AT 017 394 U1, DE 297 12 306 U1, and DE 10 2021 107 921 B4 in particular apply to coaxial conductors.

Future electric vehicles will be charged with very high currents, approx. 600-1000 A, as is also shown as an example in DE 10 2021 107 921 B4. In order to be able to transfer such high currents very high wire cross-sections are desired. For the motor vehicle production industry, it is desired to manufacture the electric wires from light metal, such as, for example, aluminum as well as its alloys in order to reduce costs and save component weight. As a result, conductors of solid instead of braided materials are increasingly used. However, there may be issues with the electrical contacting of these wires with a contact element. In particular, flat conductors or individual conductors are predominantly used. These conductors are in particular rigid conductors, which entail an elaborate bending process using many components and cost intensive production steps.

### SUMMARY

This section provides a general summary of the disclosure and is not a comprehensive disclosure of its full scope or all of its features.

The present disclosure provides a preassembled wire which can be preassembled by means of simpler processes and using less material and production effort, and which, at the same time, can withstand the mechanical load in automobiles and is suitable for high currents.

The present disclosure provides a preassembled wire and a method for preassembling a wire using the most constructively simple means, with which the connection of round conductors, in particular coaxial conductors, to other electrically conductive contact elements can be realized, so that the lowest possible electrical resistance prevails between this contacting.

The described examples likewise apply to the method for preassembling a wire. Synergistic effects can arise as a result from various combinations of examples, even if they are not described in detail.

According to one aspect of the present disclosure a preassembled wire with the following elements, not exclusively limited thereto, is described. The preassembled wire has a wire with at least two coaxially arranged conductors, wherein the wire end is stripped. The preassembled wire further has a main body, in which the wire with the stripped end is arranged, and furthermore at least one first electrically conductive plate-shaped element and a second electrically conductive plate-shaped element. At least one first electrically conductive contact socket and a second electrically conductive contact socket are arranged side by side in the main body. The first electrically conductive plate-shaped element extends between the first contact socket and the stripped wire end, wherein one side of the first plate-shaped element is connected to the first contact socket and another side opposing the first side of the first plate-shaped element is materially bonded to the stripped wire end. The second electrically conductive plate-shaped element extends between the second contact socket and the stripped wire end, wherein one side of the second plate-shaped element is connected to the second contact socket and another side opposite to the first side of the second plate-shaped element is materially bonded to the stripped wire end.

In other words, the present disclosure proposes a dual core wire, in particular a coaxial wire for use in motor vehicles, which is arranged in a main body. Each of the two conductors is connected to a corresponding contact socket by means of a plate-shaped element, wherein the connection of the wire and the contact socket is carried out via the respective plate-shaped element, which plate-shaped element is materially bonded to the wire. With the examples of the preassembled wire according to the present disclosure, the two conductors of the wire can already be assembled before a bending process of the wire, that is, they can be produced as a whole. The contact elements, such as the contact sockets which represent the interface of the wire to the, for example, adjacent high-voltage components in the vehicle, can be produced together in one manufacturing step. With the present disclosure, it is made possible to carry out the preassembly of a coaxial wire from a rigid light metal. In contrast to the flat conductors, the use of coaxial conductors results in a lower electromagnetic compatibility (EMC) load, a simpler bending process, fewer components, and fewer manufacturing steps. By means of the present disclosure in particular rigid round conductors, in particular coaxial wires can be preassembled. By using a main body for all the elements arranged therein, such as the contact elements and the plate-shaped elements and the wire, the main body can be limited to one component, which thus results in a reduction of components and consequently a reduction in costs. The use of a wire with coaxially arranged conductors, that is, in particular round conductors, allows fewer connection points to be used for integration in the motor vehicle due to the rigidity of the coaxial wires and to simplify the assembly of the preassembled wire in a motor vehicle, in particular to automate this assembly more easily. This conditioned wire configured in this way realizes a simpler bending process due to the use of the coaxially arranged conductors, which simplifies the installation space integration, that is, the integration in the vehicle.

The term “preassembled wire” in particular refers to the production of ready-to-connect wires or cables, cable bundles, and complete wiring harnesses with connectors, contacts, and connecting sleeves. The cables can be used, above all, for the electric supply of consumers, in particular automobiles. Such a preassembled cable can have/represent, for example, a connector, which can be used, in particular screwed, with a mating connector. The mating connector can be, for example, part of a charging socket or a high-voltage device.

The term two coaxially arranged conductors in particular refers to a coaxial wire, that is, a coaxial cable consisting or comprising of at least two coaxially arranged round conductors. A wire used in the present disclosure can consist or comprise, for example, of the following elements: an inner conductor in particular made of a light metal, such as aluminum, which represents, for example, the DC minus conductor, building on this an inner insulation, connected thereto an outer conductor, in particular made of light metal, such as aluminum, which represents the DC plus conductor, and furthermore an outer insulation connected thereto.

The term “stripped wire end” in particular refers to the exposure of the conductive parts of the wire. This means that the two electrically conductive conductors of the cable are exposed from their insulation so that contacting of these conductors can be realized by means of the other components of the preassembled wire. Exposing or insulating these conductors can, for example, represent an additional method step in the production of such a preassembled wire.

The term electrically conductive plate-shaped element in particular refers to a flat element, which is obtained, for example, by a punching process. The plate-shaped element can, for example, be a punching sheet that can be made from an electrically conductive material.

The term “material bond” in particular refers to the contacting of the two corresponding elements, in the present case the contacting of the wire or the exposed wire ends with the corresponding plate-shaped element using a method or production process that materially connects these two parts to each other. The material bond in particular refers to a connection of the two parts by laser welding. The conductor used in the preassembled wire according to the present disclosure in particular is an aluminum conductor, which can be contacted by means of a material connection in order to provide a solid and durable electrically conductive connection. The aluminum material can form an oxide layer on the surface, which leads to high electrical resistances in a plain non-positive connection under unfavorable environmental conditions. In order to inhibit this, the present disclosure counts on a firm bond to the isolated wire ends of the wire.

The contact sockets can, in particular, be copper sockets. The mating contacts in charging sockets or high-voltage devices are typically also made of copper and coated with silver. During the selection of the material for the contact socket it is therefore provided that the same material of the mating contacts can be selected in order to inhibit corrosion under unfavorable environmental conditions and to provide low electrical resistance.

In one example of the present disclosure, the first contact socket can have a first connecting surface and the second contact socket can have a second connecting surface, which first and second connecting surfaces are aligned in the same direction, the first and the second connecting surfaces of the contact sockets being arranged side by side on a plane and/or the plate-shaped elements extending spaced from each other on the same plane from the contact socket to the stripped wire end.

The term connecting surface in particular refers to the surface which comes in contact with the counterpart during installation, for example, in an automobile. This connecting surface is again shown in detail in the figures. According to this example, these connecting surfaces should be located on one plane. If the connecting surfaces were not located on one plane, the rigid bond produced by the coaxial wire cannot be screwed onto both boxes with the desired surface pressure. For this reason, the contact sockets according to the present disclosure are arranged on one plane with their connecting surfaces.

In one example of the present disclosure, the first contact socket and the first electrically conductive plate-shaped element can be materially bonded to each other in particular by friction welding, wherein the second contact socket and the second electrically conductive plate-shaped element can be materially bonded to each other in particular by. This means that the contact sockets can be pressed with high force onto the front side against the plate-shaped elements, for example, against the punching sheets, and welded on the front side by rotating around their own axis. A material contact, connection, of the plate-shaped elements to the contact sockets allows a secure and solid connection of these two parts, which can withstand the loads during use.

In an example of the present disclosure, the main body can have two openings opposite each other on the side on which the wire is arranged, which openings are provided to allow an access to the stripped wire end, in particular, for a material bond, in particular two sides of the main body opposite each other can be open, that is, they configure the openings opposite each other. These two sides of the main body opposite each other can either be completely open or partially open, so that a material connection can be carried out. This allows an access to the wire during the preassembling process. In particular, a high power density is desired for a material-to-material connection such as laser welding of aluminum. The opposite opening allows the laser to radiate through the main body, thus inhibiting damage to the main body.

In one example of the present disclosure, the preassembled wire can furthermore have a cover for each of the openings for sealing the respective opening, which fluid-tightly seals the respective opening, wherein the cover can be materially bonded to the main body in order to tightly seal the openings. The sealing of the cover by a material connection to the main body can be configured as an additional feature. The openings of the main body can be tightly sealed in order to protect the entire system of the preassembled wire from environmental influences. According to an example, the covers can be connected to the openings of the main body by ultrasound welding or laser welding. If, for example, ultrasound welding is used for connecting the covers to the main body, the same material can be used for both parts, that is, the cover and the main body, so that the investment costs can also be lower.

In one example of the present disclosure, the contact socket can furthermore have a screw centered therein, which is provided to allow the connection of the contact socket to a counterpart. In an example, each contact socket, that is, the first and also the second contact socket, can respectively have a screw centered therein. The contact socket, which functions as connector, can thus be connected, for example, to a mating socket, for example, a part of a charging sockets or a high-voltage device. According to this example, a screw connection of a plain plug connection can be preferred since the transition resistance is lower here, and a better electrically conductive connection can thus be provided.

In one example of the present disclosure, the first contact socket which is connected to the first electrically conductive plate-shaped element and the second contact socket which is connected to the second electrically conductive plate-shaped element can be completely enclosed by the main body. The main body can, in particular, be produced by an injection molding process, so that in this injection molding process the respective contact sockets and the respective electrically conductive plate-shaped elements can be fully overmolded in an injection molding process step. The fact that the contact sockets are overmolded together, that is, simultaneously, means that the position of the electric interfaces to each other can have very tight tolerances and their precise arrangement to each other can be provided. This further simplifies the production process of the preassembled wire. The number of components to be used can be reduced as by using a main body, which also results in a reduction in costs.

In one example of the present disclosure, the first plate-shaped element and the second plate-shaped element can be made of the same material as the two coaxially arranged conductors. If both the plate-shaped elements and the conductors of the wire are made of the same material, a better material bond can be created between these materials. In particular, a light metal, such as aluminum, is selected as the material. This means that if the conductors of the wire are made of aluminum the plate-shaped elements of the preassembled wire are likewise made of aluminum. For example, the plate-shaped elements are made of the same aluminum alloy of the wire in order to allow a sound welded connection, for example, they can be made of the following materials: EN AW-1050 or EN AW-1370. The selection of the same materials can reduce the corrosion under unfavorable environmental conditions, so that an electrical resistance stays as low as possible with this connection.

In one example of the present disclosure, the main body can furthermore have a support geometry, which is arranged in the main body and wherein the support geometry can be configured for supporting the wire during its insertion into the main body. The support geometry is configured such that the wire can be easily inserted and automatically centers itself. An insertion of the wire into the main body is simplified in this way and the wire can, in particular, be brought into the correct position by means of the support geometry. The support geometry can be arranged furthermore on an inner side of a wall of the main body and can extend inwards into the main body, while the wire can be inserted on an outer side of this wall of the main body. As a result of this example, the wire is guided inside the main body by means of the support geometry and supported in its position, so that the wire is brought into the correct position in relation to the two plate-shaped elements.

The support geometry can furthermore have lead-in chamfers for centering the wire in the main body. It is provided in this way that the wires are guided into the correct position when they are inserted into the main body and are centered in the main body. In particular, if the wire comprises or consists of an inner and an outer round conductor, which can be described as a forward moving cylinder in a simplified geometry, it is advantageous if lead-in chamfers are provided, which also guide the inner conductor of the wire to the correct position for the connection with the other elements of the preassembled wire.

According to one aspect of the present disclosure a method for preassembling a wire, in particular for use in a motor vehicle, is described. The method presents the following steps: providing the wire with an exposed stripped wire end, providing a first contact socket and a second contact socket, arranging a first electrically conductive plate-shaped element and a second electrically conductive plate-shaped element such that the first electrically conductive plate-shaped element extends between the first contact socket and the stripped wire end, and the second electrically conductive plate-shaped element extends between the second contact socket and the stripped wire end, connecting the first contact socket and one side of the first plate-shaped element, connecting the second contact socket and one side of the second plate-shaped element, enclosing the outer side of the contact sockets, the first and second plate-shaped elements, and the wire in a plastic material in order to form a main body, materially bonding another side of the first plate-shaped element to the stripped wire end, materially bonding another side of the second plate-shaped element to the stripped wire end.

In this method, the steps are not limited to the above sequence of steps, but the above sequence represents an example of the method. However, further method steps can be added, or other method steps can be removed, or existing method steps can be subdivided.

In other words, the method can, for example, proceed as follows. The electrically conductive components, that is, the wire, the first contact socket, the second contact socket, and the electrically conductive plate-shaped elements are provided and arranged such that the electrically conductive plate-shaped elements can provide a contact between the respective contact socket and the respective conductor of the wire. Each of the contact sockets is connected to one side of a plate-shaped element. After the contact sockets have been aligned and connected to the plate-shaped elements, they are enclosed by these forming the main body. The other side of the respective plate-shaped elements is then connected to the stripped wire end, that is, to the respective conductor of the wire.

In one example of the present disclosure, the connection of the stripped wire end to the first electrically conductive plate-shaped element and the connection of the stripped wire end to the second electrically conductive plate-shaped element is performed by laser welding. An ideal connection of soft metals, in particular aluminum as a conductor, to other electrically conductive metals is possible with a material connection. Aluminum forms an oxide layer on the surface, which, with a weak connection, could result in high electrical resistances under unfavorable environmental conditions. However, the challenge with welding is that the heat introduced can damage the inner insulation of the conductors, in particular the coaxial wire. At 660° C., the melting point of aluminum is many times higher than the maximum allowed temperature of the conventional isolator materials, which is approx. 120-100° C. By using laser welding of aluminum, the aluminum is only melted very locally, and the insulation of the conductors can withstand this load. A robust welding process is important in order to provide for the operational safety of the wire. Great forces can act on the welding seams depending on the wire length and the wire geometry, which uses a precise connection of the parts to be welded. This can be implemented by laser welding.

Furthermore, according to one example of the present disclosure, the connection of the first contact socket to the first electrically conductive plate-shaped element and the connection of the second contact socket to the second electrically conductive plate-shaped element can furthermore be made by friction welding.

In one example of the present disclosure, the step of enclosing the outer side of the contact sockets, the first and second plate-shaped elements, and the wire can comprise an enclosure by injection molding. This allows that the contact elements, such as the contact sockets, can be overmolded together with insulating material in one manufacturing step. Compared to the preassembly of previous wires steps in the injection molding process can therefore be saved. By overmolding all components a secure and durable alignment of the components on the corresponding component position on the configured wire can be provided.

Further features, advantages, and possible applications of the present disclosure are shown in the following description of advantageous examples and the accompanying figures.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a part of a preassembled wire according to an example of the present disclosure;

FIG. 2 is a perspective view of a preassembled wire according to an example of the present disclosure; and

FIG. 3 is a cross-sectional view of the preassembled wire according to an example of the disclosure of FIG. 2.

The figures are merely schematic representations and serve only to explain the present disclosure. Identical or similarly acting elements are consistently provided with the same reference numerals.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

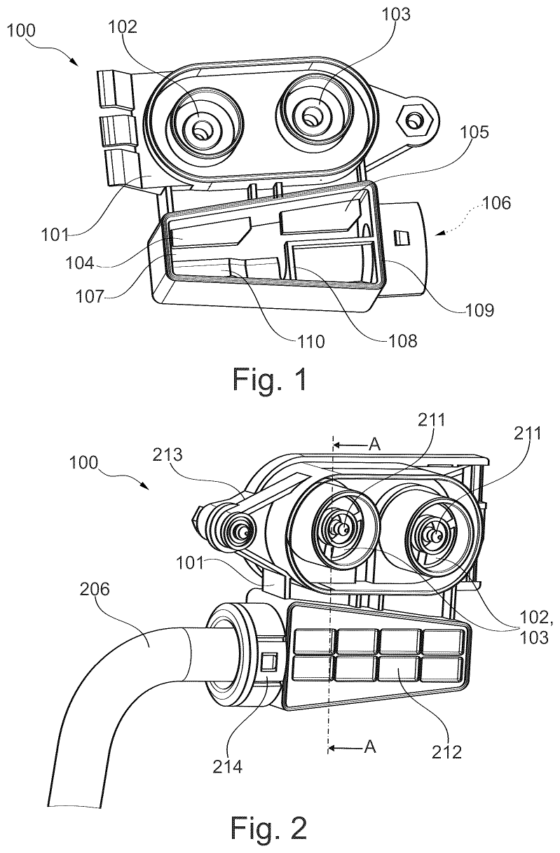

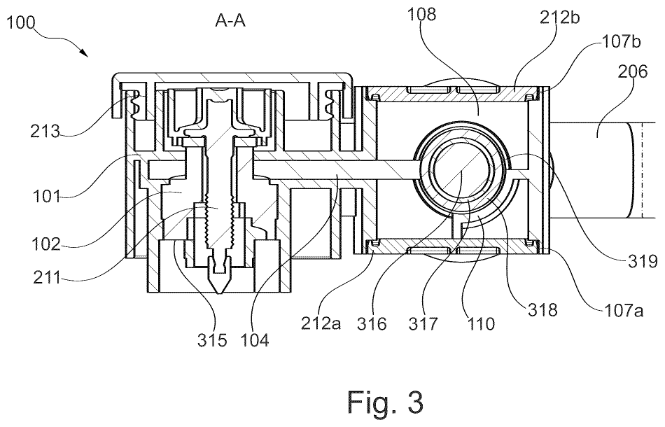

FIG. 1 shows part of a preassembled wire 100 according to an example of the present disclosure. The wire 106, represented here with a dashed arrow and not in detail, has at least two coaxially arranged conductors 316, 318 (FIG. 3) having a stripped wire end. The preassembled wire 100 further has: a main body 101 in which the wire 106 with the stripped wire end is arranged, at least one first electrically conductive plate-shaped element 104 and a second electrically conductive plate-shaped element 105. At least one first electrically conductive contact socket 102 and a second electrically conductive contact socket 103 are arranged side by side in the main body 101. In particular, the two contact sockets 102 and 103 are arranged with their respective center points side by side on the same imaginary straight line. The first electrically conductive plate-shaped element 104 extends between the first contact socket 102 and the stripped wire end of the wire 106 (not shown here), wherein one side of the first plate-shaped element 104 is connected to the first contact socket 102 and another side of the first plate-shaped element 104 opposite the first side is materially bonded to the stripped wire end. The second electrically conductive plate-shaped element 105 extends between the second contact socket 103 and the stripped wire end of the wire 106, wherein one side of the second plate-shaped element 105 is connected to the second contact socket 103 and another side of the second plate-shaped element 105 opposite the first side is materially bonded to the stripped wire end.

The main body 101 can extend over two contiguous or connected parts. In other words, the main body 101 may be divided into two opposite parts, wherein one part has the contact sockets 102, 103 and the other part has the wire 106. Both parts of the main body 101 are interconnected by means of the plate-shaped elements 104, 105 enclosed by the main body 101. The plate-shaped elements on the side of the wire 106 are exposed in this part of the main body 101, so that they can be connected to the wire 106. The first contact socket 102 and the first electrically conductive plate-shaped element 104 are materially bonded to each other, in particular, by friction welding. The second contact socket 103 and the second electrically conductive plate-shaped element 105 are also connected to each other by a material bond, in particular by friction welding. The first contact socket 102, which is connected to the first electrically conductive plate-shaped element 104, and the second contact socket 103, which is connected to the second electrically conductive plate-shaped element 105, are completely enclosed by the main body 101. In other words, the outer lateral surfaces of the contact sockets 102, 103 and the sides of the plate-shaped elements 104, 105, which are in contact with the sockets 102, 103 (electrically conductively connected thereto) are enclosed by the main body 101. In particular, these parts are enclosed by the main body 101 by injection molding.

The plate-shaped elements 104, 105 extend spaced from each other over an identical plane from the respective contact socket 102, 103 toward the stripped wire end of the wire 106 in the main body 101. In other words, the plate-shaped elements 104, 105 are arranged at the same height and extend together at the same height over a plane between the contact sockets 102, 103 and the wire 106 (or the stripped wire end).

As can be seen in FIG. 1, the main body 101 has two openings 107 opposite each other on the side at which the wire 106 is arranged. In the present FIG. 1, the main body 101 is shown from above, which is why only the upper opening 107 is visible. The openings 107 are provided in order to allow accessing the stripped wire end, in particular for a material connection. The main body 101 furthermore has a support geometry 108, which is arranged in the main body 101 and is configured for supporting the wire 106 during its insertion into the main body 101. The support geometry 108 is arranged on an inner side of a wall 109 of the main body 101 and extends inwards into the main body 101, wherein the wire 106 is inserted on an outer side of this wall 109 of the main body 101. The support geometry 108 further has lead-in chamfers 110 for centering the wire 106 in the main body 101.

FIG. 2 shows a preassembled wire 100 according to an example of the present disclosure. The preassembled wire 100 has the same elements that were already described with reference to FIG. 1. In FIG. 2, the wire 206 is furthermore integrated in the main body. The wire 206 is sealed by a seal 214, in particular a single wire seal 214. This seal 214 can be pushed onto the wire 206 before it is inserted into the main body 101.

The main body 101 is furthermore provided with a cover, a maintenance cover 213. This maintenance cover 213 is connected to the main body 101 with a folding hinge on one side and a screw connection on the other side. The folding hinge is represented best in FIG. 1 on the left side beside the contact sockets 102, 103. The screw connection of the maintenance cover 213 is shown in FIG. 2 on the left side beside the contact sockets 102, 103. In comparison to FIG. 1, the preassembled wire 100 of FIG. 2 is shown rotated along the direction of extension of the plate-shaped elements 104, 105. Other locking mechanisms, such as, for example, based on plastic clips, can likewise be used. In the case of a defect of the wire 206 or during recycling at the end of the service life, the preassembled wire 100 can be dismantled by the maintenance cover 213 allowing access to the individual components of the preassembled wire 100. In FIG. 2, each of the openings 107 is provided with a corresponding cover 212 for sealing the corresponding opening 107, which is shown fluid-tightly sealed. The covers 212 can be materially connected to the main body 101 to tightly seal the openings 107. Each of the contact sockets 102, 103 furthermore has a screw 211 centered therein, which is provided to allow to connect the respective contact socket 102, 103 to a counterpart.

FIG. 3 shows a sectional view A-A of the preassembled wire 100 according to an example of the present disclosure of FIG. 2. The preassembled wire of FIG. 3 likewise has all the features which have already been described with reference to FIGS. 1 and 2. Two opposite openings 107 a, and 107 b with the corresponding covers 212 a, and 212 b of the main body on the side of the wire 206 can now be seen in FIG. 3 on the side of the wire 206. The extension of the plate-shaped element 104 from the exposed wire end of the wire 206 to the contact socket 102 is likewise visible. It is also clear that the wire 206 is stripped inside the main body. This means that the inner conductor 216 is exposed and is in contact with the plate-shaped element 104 here and thus electrically connected to the contact socket 102. The inner insulation 317 is likewise exposed, as is the outer conductor 318, which is connected to the other plate-shaped element 105 and the other contact socket 103 (but not visible here in FIG. 3 due to the sectional view). The outer insulation 319 as the start of the stripped wire end is also shown herein.

Both plate-shaped elements 104, 105 are connected to a flat surface on the corresponding conductor 316, 318, to which they are respectively connected. In the present example, this is preferably done with a short surface on one edge of the plate-shaped elements 104, 105, although this may also be a large surface, such as the upper side or the lower side of the plate-shaped elements 104, 105. A short surface has the advantage over the latter that more space remains for assembly activities, such as welding. Also, the connection between a plate-shaped element 104, 105 and the conductor 316, 318 via a flat surface of the respective plate-shaped element 104, 105 allows a simple formation of a weld seam or a similar seam serving the connection, such as a solder seam, if the conductor 316, 318 is a round conductor and the connection to the flat surface is formed tangentially, since a natural gusset then remains between these two assemblies which can be used to configure the connection.

The first contact socket 102 has a first connecting surface 315 and the second contact socket 103 likewise has a second connecting surface, which is however not visible here, which first and second connecting surfaces 315 are aligned in the same direction, wherein the first and second connecting surfaces 315 of the contact sockets 102, 103 are arranged side by side on a plane.

Although the present disclosure has been illustrated and described in detail in the drawings and the description mentioned above, these drawings and descriptions are to be understood as illustrative or exemplary and not restrictive. The present disclosure is not limited to the disclosed examples. Other variations of the disclosed examples can be understood and implemented by persons skilled in the art practicing the claimed present disclosure by reference to the drawings, the disclosure, and the dependent claims.

It should be noted that “having” and “comprising” do not rule out other elements or steps and “one” or “a” does not exclude a plurality. It should be further noted that features or steps which were described with reference to one of the above examples can also be used in combination with other features or steps of other examples that were described above. The reference numerals in the claims are not be considered as a limitation.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A preassembled wire, comprising:
a wire having at least two coaxially arranged conductors with an insulated wire end and a stripped wire end,
a main body in which the stripped wire end of the wire is arranged,
at least one first electrically conducting plate-shaped element and a second electrically conducting plate-shaped element,
wherein at least one first electrically conducting contact socket and a second electrically conducting contact socket are arranged side by side in the main body,
wherein the at least one first electrically conducting plate-shaped element extends between the at least one first electrically conducting contact socket and the stripped wire end, one side of the at least one first electrically conducting plate-shaped element is connected to the at least one first electrically conducting contact socket, and a side opposite to the at least one first electrically conducting plate-shaped element is materially bonded to the stripped wire end and to a first conductor of the at least two coaxially arranged conductors,
wherein the second electrically conducting plate-shaped element extends between the second electrically conducting contact socket and the stripped wire end, wherein one side of the second electrically conducting plate-shaped element is connected to the second electrically conducting contact socket, and a side opposite the second electrically conducting plate-shaped element is materially bonded to the stripped wire end and to a second conductor of the at least two coaxially arranged conductors,
wherein at least one of:
the at least two coaxially arranged conductors are rigid conductors;
the main body has two openings opposite each other on the side on which the wire is arranged, the two openings are configured to provide access to the stripped wire end; and
the main body has a support geometry configured to support the wire during insertion into the main body.

2. The preassembled wire according to claim 1, wherein the at least one first electrically conducting contact socket has a first connecting surface and the second electrically conducting contact socket has a second connecting surface, the first connecting surface and the second connecting surface are aligned in the same direction, and the first connecting surface and the second connecting surface of the at least one first electrically conducting contact socket and the second electrically conducting contact socket are arranged side by side on one plane.

3. The preassembled wire according to claim 2, wherein the at least one first electrically conducting plate-shaped element and the second electrically conducting plate-shaped element extend spaced from each other over an identical plane from a respective contact socket of the at least one first electrically conducting contact socket or the second electrically conducting contact socket to the stripped wire end.

4. The preassembled wire according to claim 1, wherein the at least one first electrically conducting plate-shaped element and the second electrically conducting plate-shaped element extend spaced from each other over an identical plane from a respective contact socket of the at least one first electrically conducting contact socket or the second electrically conducting contact socket to the stripped wire end.

5. The preassembled wire according to claim 1,
wherein the at least one first electrically conducting contact socket and the at least one first electrically conducting plate-shaped element are materially bonded to each other by friction welding, and
wherein the second electrically conducting contact socket and the second electrically conducting plate-shaped element are materially bonded to each other by friction welding.

6. The preassembled wire according to claim 1, wherein the two openings are defined to allow an access to the stripped wire end for aa materially bonded connection.

7. The preassembled wire according to claim 6, further comprising a cover for each opening of the two openings, the cover configured to tightly seal a respective opening of the two openings, wherein the cover is configured to be materially bonded to the main body.

8. The preassembled wire according to claim 1, wherein at least one of the at least one first electrically conducting plate-shaped element or the second electrically conducting plate-shaped element is connected to a flat surface on a respective conductor of the at least two coaxially arranged conductors connected to at least one of the at least one first electrically conducting plate-shaped element or the second electrically conducting plate-shaped element.

9. The preassembled wire according to claim 1, wherein the at least one first electrically conducting contact socket connected to the at least one first electrically conducting plate-shaped element and the second electrically conducting contact socket connected to the second electrically conducting plate-shaped element are fully enclosed by the main body.

10. The preassembled wire according to claim 1, wherein the at least one first electrically conducting plate-shaped element and the second electrically conducting plate-shaped element are made of a same material as the at least two coaxially arranged conductors.

11. The preassembled wire according to claim 1, wherein the support geometry is arranged on an inner side of a wall of the main body and extends inwards inside the main body, wherein the wire is inserted on an outer side of the wall of the main body, and
wherein the support geometry has lead-in chamfers for centering the wire in the main body.

12. A method for preassembling a wire, comprising:
providing the wire with a stripped wire end,
providing a first contact socket and a second contact socket,
arranging a first electrically conducting plate-shaped element and a second electrically conducting plate-shaped element such that the first electrically conducting plate-shaped element extends between the first contact socket and the stripped wire end, and the second electrically conducting plate-shaped element extends between the second contact socket and the stripped wire end,
connecting the first contact socket and a side of the first electrically conducting plate-shaped element,
connecting the second contact socket and a side of the second electrically conducting plate-shaped element,
enclosing an outer side of the first contact socket and the second contact socket, the first electrically conducting plate-shaped element and the second electrically conducting plate-shaped element, and the wire with a plastic material to define a main body,
connecting another side of the first electrically conducting plate-shaped element to the stripped wire end in a materially bonded manner, and
materially bonding another side of the second electrically conducting plate-shaped element to the stripped wire end,
wherein at least one of:
two coaxially arranged conductors are rigid conductors;
the main body has two openings opposite each other on the side on which the wire is arranged, the two openings are configured to provide access to the stripped wire end; and
the main body has a support geometry configured to support the wire during insertion into the main body.

13. The method according to claim 12, wherein the connection of the stripped wire end to the first electrically conducting plate-shaped element and the connection of the stripped wire end to the second electrically conducting plate-shaped element is made by laser welding, and
wherein the connection of the first contact socket to the first electrically conducting plate-shaped element and the connection of the second contact socket to the second electrically conducting plate-shaped element is made by friction welding.

14. The method according to claim 12, wherein the enclosing the outer side of the first contact socket and the second contact socket, the first electrically conducting plate-shaped element and the second electrically conducting plate-shaped element, and the two coaxially arranged conductors comprises enclosing by injection molding.
